(19) United States
(12) Patent Application Publication
(10) Pub. No.: US 2005/0164767 A1
(43) Pub. Date: Jul. 28, 2005

(54) System and method of providing a guarantee in a lottery

(76) Inventor: Robert J. Wright, Irving, TX (US)

Correspondence Address: GREENBERG TRAURIG LLP, 2450 COLORADO AVENUE, SUITE 400E, SANTA MONICA, CA, 90404, US

(21) Appl. No.: 10/766,656

(22) Filed: Jan. 27, 2004

(51) Int. Cl. A63F 9/24; G06F 19/00; G06F 17/00

(52) U.S. Cl. 463/17

(57) ABSTRACT

A system and method of assuming risk for a lottery. A guarantee of payment of a prize in a lottery is provided. The guarantee is in exchange for a stipulation of a percentage of ticket sales revenue in the lottery. In addition, the guarantee occurs prior to the ticket sales in the lottery. The percentage of the ticket sales in the lottery is received. Further, the prize can be a jackpot. In addition, the lottery prize can be a variable prize that progressively increases with a percentage of each ticket sold. The prize can also be a fixed prize. The guarantee can be that the payment of the prize will be paid even if the ticket sales are not sufficient in size to effect payment of the prize.

### RELATED APPLICATIONS

This application is related to Multiple Pricing Shared Single Jackpot in a Lottery by Robert J. Wright, which is hereby incorporated by reference in its entirety.

### BACKGROUND

1. Field

A system and method are disclosed which generally relate to lotteries.

2. General Background

A lottery is generally a distribution of tokens such that a subset of the distributed tokens may win a prize. The token can be in the form of a ticket. One of the most popular forms of lottery involves the distribution of lottery tickets. Each lottery ticket includes a lottery number. After the lottery tickets have been distributed to the lottery ticket holders, the winning number is chosen. The usual method of selecting the winning number involves a random selection of the winning number. A ball draw machine or a random number generator can be used to randomly select the winning number. Some lottery systems require the ticket to have the entire number that is randomly selected while other lottery systems require the ticket to have a superset of an ordered sequence of numbers that are randomly selected.

Lotteries are normally used by jurisdictions according to a pari-mutuel model in which the prize is funded by a portion of the ticket sales. Accordingly, a large number of tickets need to be sold in the pari-mutuel model in order to create a large jackpot prize. However, interest in purchasing lottery tickets is generally stimulated only when the prize becomes substantial. For instance, a large number of lottery tickets are purchased in a $10 million dollar lottery, but a disproportionately large number of lottery tickets are purchased in a $50 million dollar lottery.

### SUMMARY OF THE INVENTION

In one aspect, a method assumes risk for a lottery. The method provides a guarantee of payment of a prize in a lottery. Further, the guarantee is in exchange for a stipulation of a percentage of ticket sales revenue in the lottery. In addition, the providing the guarantee occurs prior to the ticket sales in the lottery. Finally, the method receives the percentage of the ticket sales revenue in the lottery.

In another aspect, a lottery risk assumption system is disclosed. A prize guarantee system provides a guarantee of payment of a prize in a lottery. Accordingly, the prize guarantee system provides the guarantee in exchange for a stipulation for a percentage of ticket sales revenue in the lottery. In addition, the prize guarantee system provides the guarantee prior to the ticket sales in the lottery. Finally, a receiving system receives the percentage of the ticket sales revenue in the lottery.

In yet another aspect, a method assumes risk for a game of chance. The method provides a guarantee of payment of a prize in a game of chance. Further, the guarantee is in exchange for a stipulation for a percentage of wages bet in the game of chance. In addition, the providing the guarantee occurs prior to the betting of wages in the game of chance. Finally, the method receives the percentage of wages bet in the game of chance.

In another aspect, a lottery system is disclosed. A guarantee transmission module transmits a guarantee through a network. Accordingly, the guarantee guarantees the payment of a predetermined lottery prize. Further, a guarantee reception module receives the guarantee through the network. Finally, a lottery creation module establishes a lottery in which players can purchase tickets to win the predetermined lottery prize upon receipt of the guarantee from the guarantee reception module.

In yet another aspect, a game of chance guarantee system is disclosed. A guarantee transmission module transmits a guarantee through a network. Accordingly, the guarantee guarantees the payment of a predetermined prize in a game of chance. Further, the prize can be won by winning the game of chance. In addition, the game of chance is played according to a plurality of rules. Accordingly, the guarantee is provided in exchange for a stipulation for a percentage of the wagers. Further, a guarantee reception module receives the guarantee through the network. A game of chance creation module establishes the game of chance upon receipt of the guarantee from the guarantee reception module. The players can make wagers in the game of chance.

In yet another aspect, a method guarantees a probabilistic lottery system. The method provides a guarantee for a pre-determined prize. Accordingly, the pre-determined prize can be advertised by a lottery operator. In addition, the pre-determined prize is increased by a percentage of each ticket sale after each ticket sale. Finally, the method receives a stipulation for a percentage of ticket sales revenue in exchange for the providing the guarantee.

### BRIEF DESCRIPTION OF THE DRAWINGS

By way of example, reference will now be made to the accompanying drawings.

FIG. 1 illustrates a lottery system that is based on a pari-mutuel model.

FIG. 2 illustrates a probabilistic lottery system.

FIG. 3 illustrates a process in which the jackpot guarantor provides a guarantee for the pre-determined jackpot to the lottery operator.

FIG. 4 illustrates a probabilistic software configuration that can be used with the probabilistic lottery system.

FIG. 5 illustrates a hardware and software configuration which the jackpot guarantor can use to transmit and receive data from the lottery operator.

FIG. 6 illustrates the hardware and software configuration illustrated in FIG. 5 that is used to communicate with the point of sale.

FIG. 7 illustrates the probabilistic lottery system illustrated in FIG. 2 with the jackpot guarantor obtaining insurance from an insurance entity.

FIG. 8 illustrates a process for determining if the jackpot guarantor needs to invoke the insurance policy obtained from the insurance entity.

FIG. 9 illustrates a probabilistic hardware and software configuration that can be used with a game of chance.

### DETAILED DESCRIPTION OF THE INVENTION

A method and system are disclosed for improving the revenue generated through a lottery. In one embodiment, an entity assumes the risk of the lottery prize. The entity can be a guarantor. The entity provides a guarantee to a jurisdiction that a pre-determined lottery prize will be paid if there is a winner of the lottery. In exchange for the guarantee, the jurisdiction provides a stipulation that a percentage of future ticket sales revenue will be paid to the entity. In one embodiment, the guarantee can be part of a written contract. In another embodiment, the stipulation can be part of a written contract. In yet another embodiment, the contract can include a guarantee and a stipulation. In another embodiment, the contract can be electronic. The jurisdiction can significantly increase lottery ticket sales by advertising the generally larger pre-determined lottery. In another embodiment, the entity provides the prize money for a lottery to the jurisdiction so that the jurisdiction can have a large jackpot to attract the large number of purchasers. The entity can charge a fee to the jurisdiction. Further, in another embodiment, an insurance company insures the entity in the case that a purchaser wins a large lottery without a sufficient number of lottery tickets being purchased.

In another embodiment, multiple pricing for a predetermined single jackpot in a single lottery game is disclosed. For instance, a lottery ticket that is purchased for one dollar can result in a ten million dollar win, a lottery ticket that is purchased for two dollars can result in a twenty million dollar win, a lottery ticket that is purchased for three dollars can result in a twenty million or thirty million dollar win, etc. The prizes are won from a single pool. For instance, even if the revenues for the one dollar ticket do not cover the ten million dollar prize, the combined revenues of the one dollar and the two dollar tickets are likely to cover the ten million dollar prize and vice versa. In one embodiment, a shared multiple pricing lottery game with a single pre-determined jackpot is disclosed. For example, a lottery player having a one dollar ticket attempting to win ten million dollars and a lottery player having a two dollar ticket attempting to win twenty million dollars can both win a prize. The lottery player having the one dollar ticket will receive a portion of the ten million dollar prize and will have to share the other portion with the lottery player having the two dollar ticket. Accordingly, the two dollar ticket holder receives the remaining portion of the ten million dollars and an additional ten million dollars because the two dollar ticket holder would have been entitled to twenty million dollars if the two dollar ticket holder won the lottery alone. The shared multiple pricing lottery game is not limited to one dollar and two dollar tickets. For example, a three dollar ticket could also be provided. The three dollar ticket holder would share the lottery prize with the two dollar ticket holder and the one dollar ticket holder in a similar manner to which the two dollar ticket holder shared the lottery prize with the one dollar ticket holder.

The average revenue per ticket sold of the multiple pricing revenues can result in higher revenue than traditional lottery systems. A lottery may be able to cut down on expenses by paying less to ticket holders that purchase the inexpensive tickets while at the same time attracting more ticket holders who will only play if the jackpot is large. The multiple pricing system can be used independently or in conjunction with the entity as discussed above.

In one embodiment, the jackpot is increased with a percentage of the revenue from each ticket sold. In other words, a minimum amount of ticket sales is not required for the contribution of ticket sales revenue into the jackpot. The addition of a percentage of ticket sales to the jackpot is a progressive jackpot. In essence, a variable prize is offered with a progressive jackpot. The prize can increase with each ticket sale. In one embodiment, the prize increases with a portion of the ticket sales. In another embodiment, the progressive jackpot can be divided among multiple winners.

In one embodiment, fixed prizes can be offered in addition to or without the jackpot prize. A fixed prize is a prize that is not shared. If a lottery player has the winning number for a fixed prize, the lottery player receives the entire fixed prize. If multiple lottery players have the winning numbers for the fixed prize, then multiple lottery players each receive the entire fixed prize without having to share the fixed prizes with the other players. The fixed prize is different from the jackpot prize in which multiple winners share the jackpot prize. The fixed prizes can be distributed in entirety to multiple players because the fixed prizes are generally much smaller than the jackpot prize. In one embodiment, the fixed prize can be the jackpot prize. Multiple players could win the jackpot prize without having to share the jackpot prize.

In one embodiment, if there is not winning ticket in the present lottery draw, a rollover is provided. The rollover allocates funds based on present ticket sales for a future lottery. In one embodiment, the progressive prize in the present lottery is rolled over to a future lottery draw if there is no winner in the present lottery draw. In one embodiment, the roll over includes a percentage of the jackpot for use in a future draw.

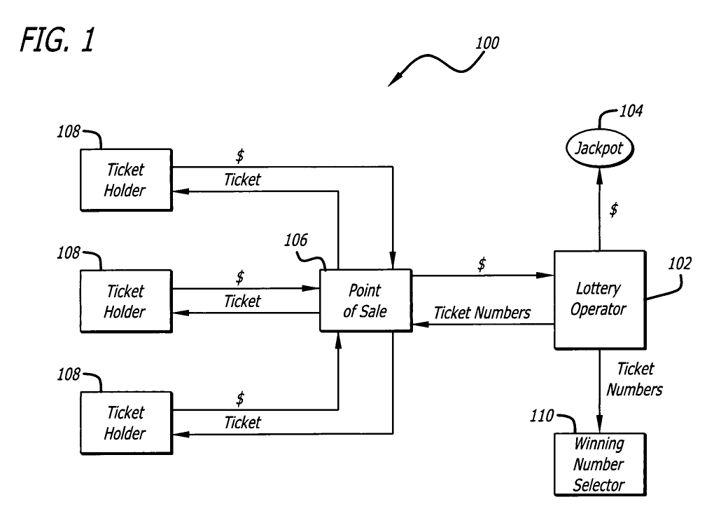

FIG. 1 illustrates a lottery system 100 that is based on a pari-mutuel model. A lottery operator 102 establishes the lottery. The lottery operator 102 can be a jurisdiction such as a state, city, town, municipality, or any division or department thereof. Further, the lottery operator 102 can be a private organization that a jurisdiction hires or licenses to coordinate the lottery. The lottery operator 102 can also be a private organization that is not hired by a jurisdiction. The coordination involved can include, inter alia, establishment, operations, ticket sales, advertising, systems/terminals, game design, maintenance, and/or winnings determination.

The lottery operator 102 can advertise that a lottery has a prize. For example, the lottery operator 102 can advertise that the lottery prize will be a minimum of ten million dollars. The lottery operator 102 provides the lottery prize from a jackpot 104. The jackpot 104 is filled in the following manner. A point of sale 106 provides a ticket to a ticket holder 108 and receives payment for the ticket. One of ordinary skill in the art will recognize various forms of payment such as cash, electronic payments such as credit card, wireless payments, etc. Further, one of ordinary skill in the art will recognize that the point of sale 106 can be located in any environment in which merchandise is sold. The point of sale 106 transfers the payment and the ticket number to the lottery operator 102. The lottery operator 102 then places the payment into the jackpot 104. In one embodiment, the lottery operator 102 places only a percentage of the payment into the jackpot 104. The lottery operator 102 can use the remaining portion of the payment for profit, expenditures, other prizes such as fixed prizes, charitable causes, etc.

If the payments in the jackpot 104 add up to surpass the advertised minimum and there is a winner of the jackpot, the lottery operator 102 can choose to pay the advertised minimum or the total amount from the payments in the jackpot 104. However, if the payments in the jackpot 104 add up as being less than the advertised minimum and there is a winner of the jackpot, the lottery operator has provides the difference between the advertised minimum and the sum of the payments.

After the payments in the jackpot 104 surpass the advertised minimum, the jackpot 104 can be increased. In other words, a portion of each payment that surpasses the advertised minimum can be allocated to the jackpot 104. The other portion of each payment can be retained by the lottery operator 102.as revenue. The revenue can cover costs associated with the lottery. Further, the revenue can be used to fund other activities. For example, if the lottery operator 102 is a jurisdiction, some of the expenditures made by the jurisdiction can be funded at least in part by the revenue generated from the lottery.

In one embodiment, after the payments in the jackpot 104 surpass the advertised minimum, the jackpot 104 increases by at least a percentage of the ticket sales. However, the jackpot 104 is unlikely to increase significantly beyond the minimum because potential ticket holders are not likely to gain interest in a small jackpot.

The lottery operator 110 uses a winning number selector 110 to determine if one of the ticket holders 108 is a winner of the jackpot 104 or a portion of the jackpot 104. The winning number selector 110 can be a random number generator. Further, the winning number selector 110 can be any mechanism that allows the lottery operator 110 to randomly select a winning number.

One of the difficulties with the lottery system 100 is that the lottery operator 102 must assume the risk for providing the difference between the advertised minimum and the payments received from tickets sales. The lottery operator 102 generally advertises a relatively small minimum compared with potential jackpots in order to reduce the risk. However, much of the risk exists because of the size of the minimum. A relatively small minimum that is advertised will generally invoke less interest than a very large jackpot. The lottery system 100 increases the jackpot 104 only after the minimum is surpassed. The lottery system 100 sometimes requires several lotteries before the combination mode is ever reached. In some configurations, the lottery system 100 does not involve the lottery operator 102 advertising a minimum. The ticket holder simply wins whatever is in the jackpot 104. Although the risk is somewhat diminished, the potential rewards are also diminished because enough interest cannot be stimulated to provide for a very large jackpot.

Some ticket holders 108 generally buy lottery tickets in almost any lottery regardless of the size of the jackpot 104. However, the number of ticket holders 108 exponentially increases with a very large jackpot 104 because ticket holders 108 that would never have bought a lottery ticket are willing to purchase a lottery ticket for a very large prize even though the chances of winning are small.

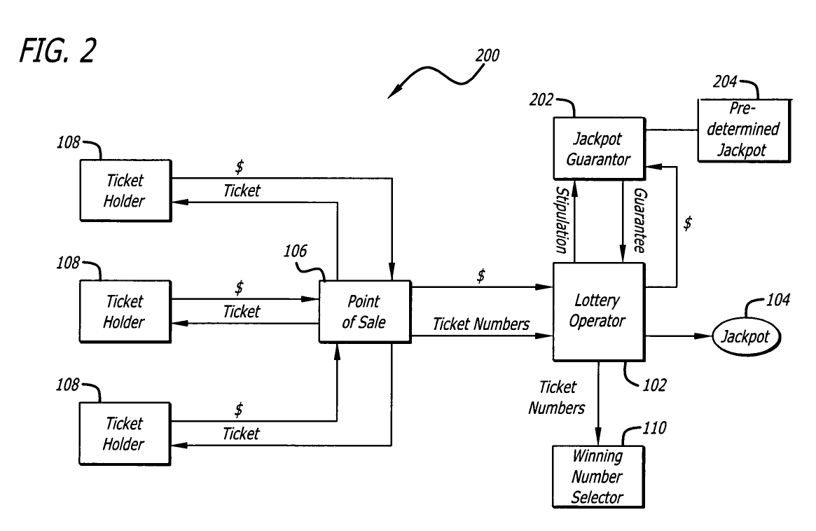

FIG. 2 illustrates a probabilistic lottery system 200. A jackpot guarantor 202 assumes the risk that would normally be assumed by the lottery operator 102. In one embodiment, the jackpot guarantor 202 is a private organization other than a jurisdiction. In another embodiment, the jackpot guarantor 202 is a publicly held company other than a jurisdiction. The jackpot guarantor 202 establishes a pre-determined jackpot 204. In one embodiment, the pre-determined jackpot 204 is a very large prize that will invoke ticket holders 108 that would not normally purchase a lottery ticket to purchase a lottery ticket. The lottery operator 102 can advertise with the pre-determined jackpot 204 in order to invoke higher ticket sales than would otherwise be achieved. In one embodiment, the pre-determined jackpot 204 does not actually contain any funds. Rather, the jackpot guarantor 202 determines the pre-determined jackpot 204 that is large enough so that there is a low probability of generating ticket sales that are less than the pre-determined jackpot 204. If the ticket sales are less than the pre-determined jackpot 204, the jackpot guarantor 202 assumes the risk for paying the difference between the ticket sales and the pre-determined jackpot 204. In another embodiment, the jackpot guarantor 202 determines the pre-determined jackpot 204 that is large enough so that there is a low probability of generating a percentage of ticket sales that are less than the pre-determined jackpot 204. If the percentage of ticket sales is less than the pre-determined jackpot 204, the jackpot guarantor 202 assumes the risk for paying the difference between the percentage of the ticket sales and the pre-determined jackpot 204.

In one embodiment, the probabilistic lottery system 200 is progressive. In one embodiment, a minimum amount of ticket sales is not required. The lottery prize can be a variable prize from the outset. A percentage of each ticket sale can be contributed to the variable prize jackpot.

In one embodiment, the jackpot guarantor 202 provides a guarantee to the lottery operator 102. In one embodiment, the guarantee provides that the jackpot guarantor 202 assumes the risk for paying the pre-determined jackpot if the ticket sales are not sufficient to cover the pre-determined jackpot. In another embodiment, the guarantee provides that the jackpot guarantor assumes the risk for paying a portion of the pre-determined jackpot for any secondary prizes that are won.

In one embodiment, the jackpot guarantor 202 provides the guarantee in exchange for a stipulation. In one embodiment, the guarantee is contractual. In one embodiment, the stipulation includes an obligation by the lottery operator 102 to provide a percentage of revenue generated from future ticket sales in exchange for the guarantee. In one embodiment, the stipulation is contractual. In one embodiment, the exchange of the guarantee for the stipulation and vice versa is contractual. In another embodiment, the stipulation includes an obligation by the lottery operator 102 to provide a fee in exchange for the guarantee.

The lottery operator 102 receives payments for ticket sales from the point of sale 106. Further, the lottery operator 102 receives ticket numbers from the tickets sold to the ticket holders 108 from the point of sale 106. The lottery operator provides the ticket numbers to the winning number selector 110.

In one embodiment, the jackpot guarantor 202 places the funds in the pre-determined jackpot 204. Therefore, the lottery operator can advertise a large prize because another entity actually has the large prize.

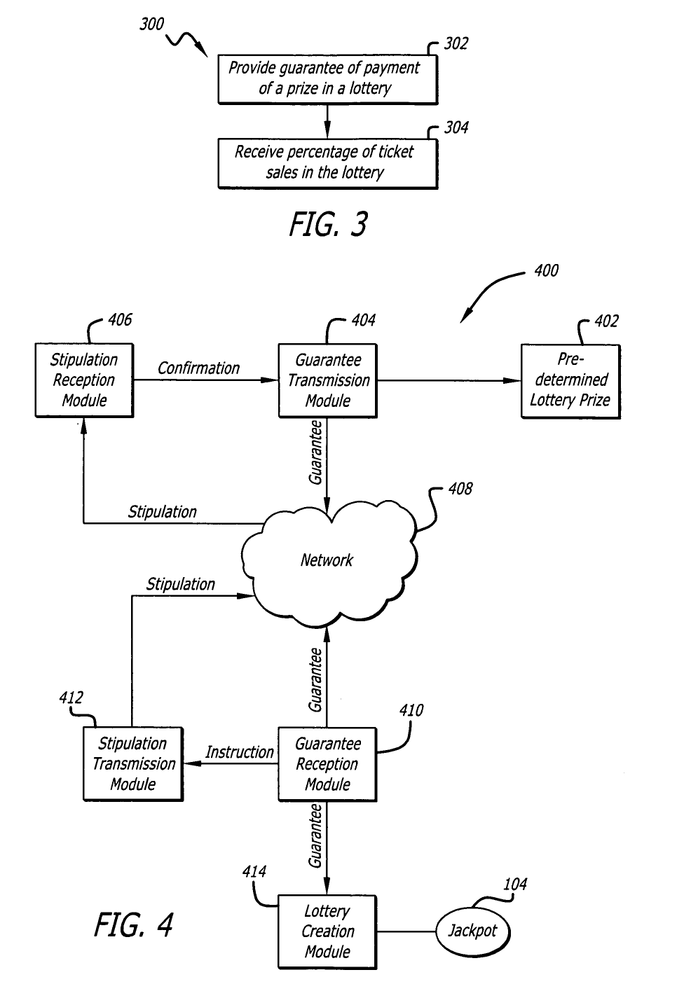

FIG. 3 illustrates a process in which the jackpot guarantor 202 provides a guarantee for the pre-determined jackpot 204 to the lottery operator 102. At a process block 302, a guarantee of payment of a prize in a lottery is provided. In one embodiment, the guarantee of the payment of the prize in the lottery is provided in exchange for a percentage of ticket sales. At a next process block 304, a percentage of ticket sales is received.

FIG. 4 illustrates a probabilistic software configuration 400 that can be used with the probabilistic lottery system 200 (FIG. 2). As can be seen from FIG. 4, the probabilistic software configuration 400 includes software for establishing a guarantee for a pre-determined lottery prize 402. A guarantee transmission module 404 transmits the guarantee through a network 408. The network 408 can be a wide area network, a local area network, the network, a wireless network, or any other network known to one of ordinary skill in the art. The guarantee transmission module 404 transmits the guarantee in exchange for a stipulation. In one embodiment, the guarantee can be a copy of a written guarantee that is sent electronically. In another embodiment, the guarantee can be an electronic guarantee. In one embodiment, the stipulation can be an obligation for a percentage of future ticket sales. A stipulation reception module 406 receives the stipulation through the network 408. In one embodiment, after the stipulation reception module 406 receives the stipulation, the stipulation reception module 406 transmits a confirmation that the stipulation was received to the guarantee transmission module 404.

A guarantee reception module 410 receives the guarantee from the network 408. In one embodiment, upon receiving the guarantee, the guarantee reception module 410 provides an instruction to a stipulation transmission module 412. The stipulation transmission module 412 then sends the stipulation through the network 408. In one embodiment, the stipulation can be a copy of a written stipulation that is sent electronically. In another embodiment, the stipulation can be an electronic stipulation. As discussed above, the stipulation reception module 406 can receive the stipulation and send the confirmation to the guarantee transmission module 404 that the guarantee has been sent and the stipulation, in exchange for which the guarantee was sent, has been received.

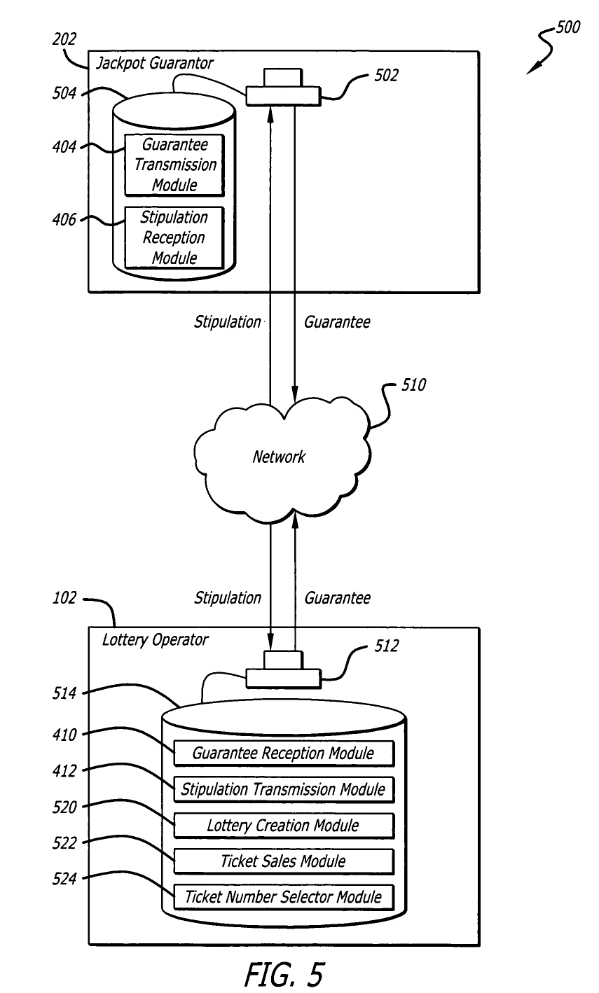

FIG. 5 illustrates a hardware and software configuration 500, which the jackpot guarantor 202 can use to transmit and receive data from the lottery operator 102. The jackpot guarantor 202 has a client computer 502 which is operably connected to a network 510. The client computer 502 can be implemented on any computing device known to one of ordinary skill in the art. For example, the client computer 502 can be implemented on a PC, a laptop, a personal digital assistant (PDA), a cellular phone, an MP3 player, etc. The network 510 can be a local area network, a wide area network, the Internet, a wireless network, etc. In one embodiment, the client computer 502 can also act as a server. In another embodiment, the jackpot guarantor 202 includes the client computer 502 and a separate server (not shown). The client computer 502 is coupled to a data storage 504. The data storage 504 includes the guarantee transmission module 404. Further, the data storage 504 includes the stipulation reception module 406. In one embodiment, the client computer 502 includes a processor (not shown) that instructs the guarantee transmission module 404 to transmit the guarantee through the network 510. The processor can also be alerted by the stipulation reception module 406 that a stipulation has been received.

The lottery operator 102 includes a client computer 512 which is operably connected to the network 510. The client computer 512 can be implemented on any computing device. For example, the client computer 512 can be implemented on a personal computer (PC), a laptop, a personal digital assistant (PDA), a cellular phone, an MP3 player, etc. In one embodiment, the client computer 512 can also act as a server. In another embodiment, the lottery operator 102 includes the client computer 512 and a separate server (not shown). The client computer 512 receives the guarantee from the network 510. The client computer 512 includes a data storage 514. Accordingly, the data storage 514 can have stored therein the guarantee reception module 410, the stipulation transmission module 412, a lottery creation module 520, a ticket sales module 522, and a ticket number selector module 524. The guarantee reception module 410 can be used to receive the guarantee that is sent by the guarantee transmission module 504 through the network 510 from the jackpot guarantor 202. Further, the stipulation transmission module 412 can be used to send the stipulation through the network 510 to the stipulation reception module at the jackpot guarantor 202.

The lottery creation module 520 can be used to set up a lottery. Further, the. ticket sales module 522 can be used to record the number of tickets sold. In one embodiment, the ticket sales module 522 can record the revenues made from the ticket sales. In one embodiment, the ticket sales module 522 communicates with the stipulation transmission module to determine the contents of the stipulation that was sent to the jackpot guarantor. The ticket sales module 522 then calculates the portion of the revenue that the lottery operator 102 must provide to the jackpot guarantor 202. In one embodiment, the stipulation is a percentage of the revenue earned from each ticket sold. The ticket sales module 522 can calculate this percentage by multiplying the number of tickets sold times the revenue per ticket times the percentage sent in the stipulation. Finally, the ticket number selector module 524 determines the winning lottery number that a lottery ticket must have in order to considered a winning ticket.

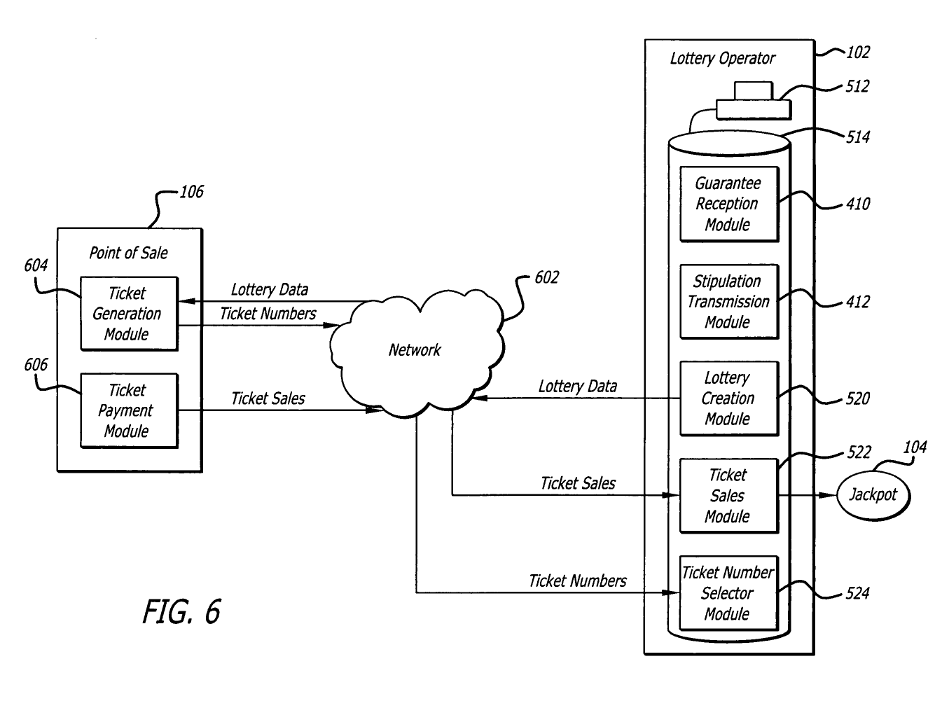

FIG. 6 illustrates the hardware and software configuration illustrated in FIG. 5 that is used to communicate with the point of sale 106. The lottery creation module 520 sends lottery data through a network 602 to the point of sale 106. The network 510 can be a local area network, a wide area network, the Internet, a wireless network, etc.

A ticket generation module 604 receives the lottery data through the network 602. The ticket generation module 604 needs to know that a lottery exists before the ticket generation module 604 can generate lottery tickets. The lottery data can also include data concerning the predetermined jackpot 204. The amount of the pre-determined jackpot 204 can be advertised at the point of sale 106 to help invoke the purchase of lottery tickets. Further, the amount of the pre-determined jackpot 204 can be printed on the lottery ticket. In one embodiment, the ticket generation module 604 collects the various lottery numbers chosen by the purchasers of the lottery tickets and transmits the lottery ticket numbers through the network 602 to the ticket number selector module 524. Accordingly, the ticket number selector module 524 can randomly select the winning lottery number. In one embodiment, the ticket number selector module 524 can determine if the winning lottery number was issued on any of the lottery tickets purchased at the point of sale 106 by comparing the ticket numbers received with the randomly selected winning lottery number. In one embodiment, the ticket number selector module 524 makes the random selection with the use of a random number generator.

In one embodiment, the point of sale 106 also has a ticket payment module 606 that sends ticket sales data through the network 602 to the ticket sales module 522. The ticket sales data can include data such as the number of tickets sold, the price of each ticket sold, etc. The ticket sales data can be used by the ticket sales module 522 as discussed above. Further, in one embodiment, the ticket sales module 522 can place a portion or the entirety of the revenue generated from each ticket sold into the jackpot 104. In another embodiment, the ticket sales module 522 can place a portion or the entirety of the revenue generated from each ticket sold into the pre-determined jackpot 204.

In one embodiment, the point of sale has a computing device (not shown). The computing device is coupled to a data storage (not shown) that stores the ticket generation module 604 and the ticket payment module 606. The computing device can be any computing device as discussed above. Further, the ticket generation module 604 and the ticket payment module 606 can be stored on multiple data storage devices.

The revenues from each ticket sold can be placed into the pre-determined jackpot 204 from the outset of the lottery. In contrast to a lottery with a jackpot that does not increase until a minimum is surpassed, or in contrast to a lottery that does not have the pre-determined jackpot 204, the probabilistic lottery system 200 (FIG. 2) can attract a large number of lottery ticket purchasers with a large pre-determined jackpot 204 that will increase with every ticket sale. The use of the progressive model induces purchasers to purchase tickets because they can win a variable prize that can increase above the advertised prize. With a very large advertised prize, potential lottery ticket purchasers are initially induced to purchase lottery tickets and are even further induced by the lottery prize being progressive.

The software modules discussed above can be used to establish and coordinate the probabilistic lottery system 200. The use of computerized technologies can help facilitate calculating the transmission and reception of the a large quantity of guarantees and stipulations. Without the computerized technologies, the transportation of documents for the guarantees and stipulations could be burdensome.

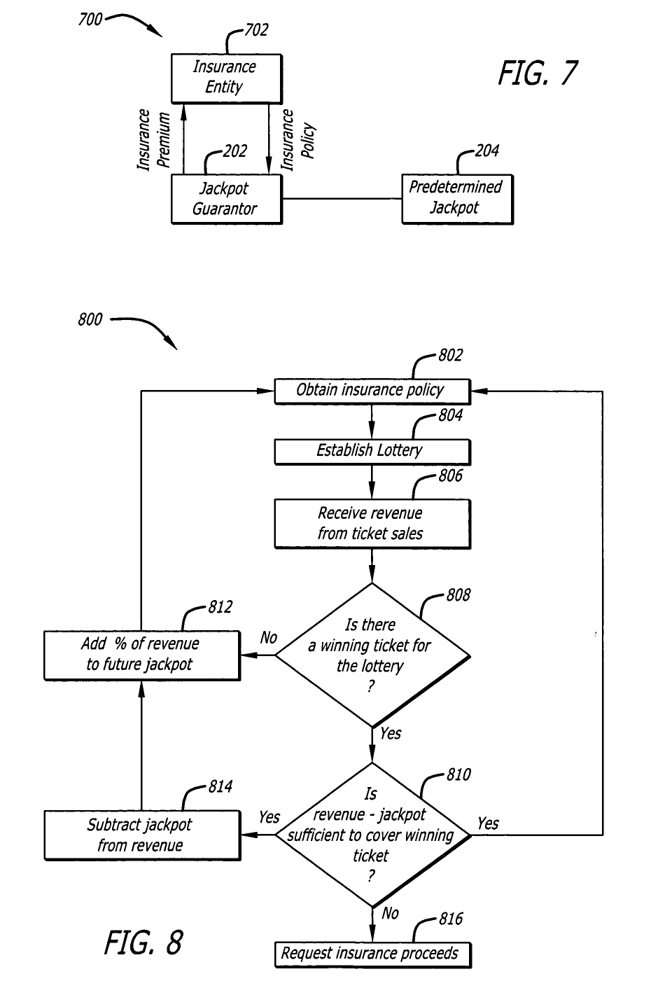

FIG. 7 illustrates the probabilistic lottery system 200 illustrated in FIG. 2 with the jackpot guarantor 202 obtaining insurance from an insurance entity 702. The jackpot guarantor 202 pays an insurance premium to the insurance entity 702 to obtain an insurance policy. The jackpot guarantor 202 obtains the insurance policy to insure that the jackpot guarantor can pay the pre-determined jackpot 204 in the event that ticket sales are insufficient to cover the pre-determined jackpot 204. The insurance entity 702 is not limited to an insurance company. Rather, the insurance entity 702 can be any financial institution. Further, the insurance policy is not limited to an insurance policy issued by an insurance company. Rather, the insurance policy can be any financial agreement in which the insurance entity 702 agrees to pay the difference between the pre-determined jackpot 204 and the revenues received from the ticket sales if the revenues received from the ticket sales are insufficient to cover the pre-determined jackpot 204.

FIG. 8 illustrates a process 800 for determining if the jackpot guarantor 202 needs to invoke the insurance policy obtained from the insurance entity 702. At a process block 802, the jackpot guarantor 202 obtains an insurance policy. At a process block 804, a lottery is established. The lottery operator 102 can establish the lottery. In one embodiment, the lottery operator 102 establishes the lottery through the lottery creation module 520 as discussed above. At a process block 806, the lottery operator receives revenue from ticket sales. In one embodiment, the lottery operator tabulates the ticket sales through the ticket payment module 606. At a decision block 808, the process 800 determines if there is a winning ticket for the lottery. If the process 800 determines that there is not a winning ticket for the lottery, the process 800 advances to a process block 812 where a percentage of the revenue is added to a future jackpot. In other words, the process 800 provides a rollover in allocating funds based on present ticket sales for a future lottery. In one embodiment, the roll over includes a percentage of the jackpot for use in a future draw. In one embodiment, the lottery operator 102 takes a percentage of the ticket sales revenue and adds that percentage to a future lottery jackpot even if there is a winner in the present jackpot. The process 800 then advances back to the process block 802. If the process determines that there is a winning ticket for the lottery at the decision block 808, then the process 800 advances to a decision block 810. At the decision block 810, the process 800 determines if the revenue received from the ticket sales is sufficient to cover the pre-determined jackpot 204. If the revenues are sufficient to cover the winning ticket, the process 800 advances to a process block 814 where the jackpot is subtracted from the revenues received from the ticket sales. The process then advances to the process block 812 where a percentage of the remaining revenues after the subtraction at the process block 814 is added to the future jackpot. If the revenues are insufficient to cover the winning ticket, the process 800 advances to a process block 816 where a request for insurance proceeds to cover the difference between the jackpot and the revenues received from the ticket sales. In one embodiment, the process 800 can be stored on a computer readable medium.

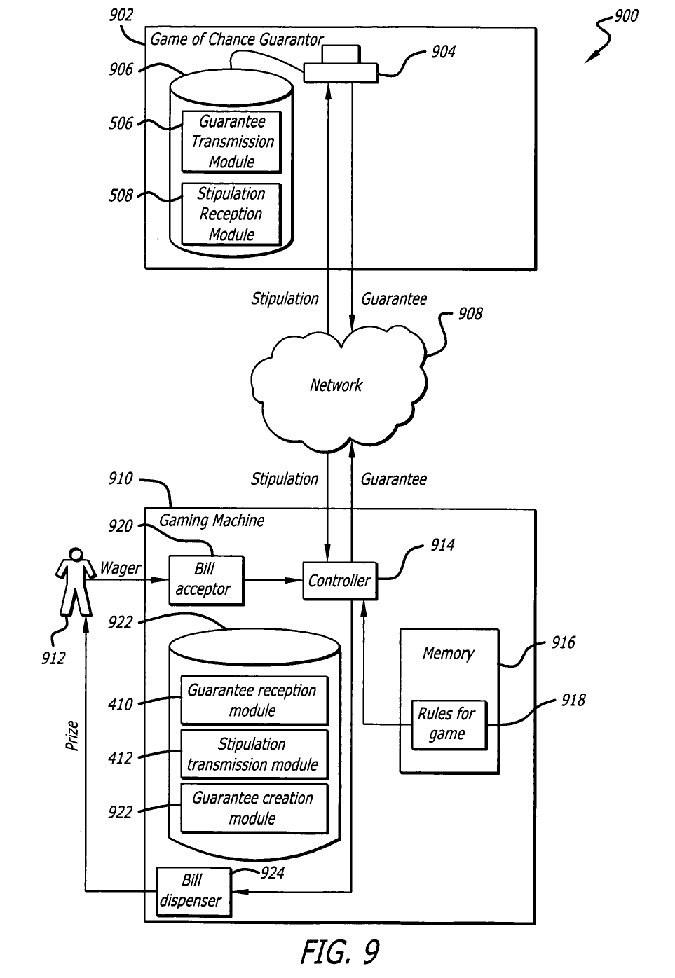

FIG. 9 illustrates a probabilistic hardware and software configuration 900 that can be used with a game of chance. Accordingly, the game of chance can be any game in which a wager is made in order to win a prize. For example, Poker, Blackjack, and Keno are all games of chance. In one embodiment, a game of chance guarantor 902 provides a guarantee that the prize will be paid if a player of the game of chance wins. In one embodiment, the game of chance guarantor has a client computer 904. Accordingly, the client computer 904 is coupled to a data storage 906. In one embodiment, the data storage 906 stores the guarantee transmission module 506 and the stipulation reception module 508. The client computer 904 can be implemented in any computing device. For example, the client computer 904 can be implemented on a PC, a laptop, a personal digital assistant (PDA), a cellular phone, an MP3 player, etc. Further, the client computer 904 can also act as a server. The guarantee transmission module 506 sends a guarantee through a network 908. Accordingly, the network 908 can be a local area network, a wide area network, the Internet, a wireless network, etc. Further, the stipulation reception module 508 receives a stipulation from the network 908.

A gaming machine 910 is also operably connected to the network 908. The gaming machine includes a data storage 922. Accordingly, the data storage 922 can have stored therein the guarantee reception module 410, the stipulation transmission module 412, and a game creation module 924. The guarantee reception module 410 can be used to receive the guarantee that is sent by the guarantee transmission module 504 through the network 908 from the game of chance guarantor 902. Further, the stipulation transmission module 412 can be used to send the stipulation through the network 908 to the stipulation reception module at the game of chance guarantor 902.

The gaming machine 910 also includes a controller 914. Accordingly, the controller 914 coordinates the playing of a game by a player 912 that uses the gaming machine 910. In one embodiment, the controller can initiate the playing of a game after the guarantee reception module receives the guarantee. In one embodiment, after the guarantee is received, the gaming machine 910 has a bill acceptor 920 that can accept a wager made in cash to initiate game play. One of ordinary skill in the art will recognize that the bill acceptor 920 can also accept electronic forms of payment such as credit card payment. In one embodiment, the controller 914 is operably connected to a memory 916. A rules module 918 can be stored on the memory 916 so that the controller 914 can establish how the game of chance is to be played, how the game of chance is to be won, and how the game of chance is to be lost. Further, a random number generator (not shown) can be used by the controller 914 to randomly select numbers, cards, balls, or whatever is need to be randomly chosen according to the rules module 918. After the player 912 makes a wager and wins a prize, the controller 914 can provide an instruction to a bill dispenser 924 to distribute the prize in cash. In another embodiment, a coin dispenser (not shown) can dispense the prize in coins. In yet another embodiment, a winnings dispenser (not shown) can dispense the prize in a combination of cash and coins. In another embodiment, a ticket dispenser (not shown) can dispense a redeemable ticket for the amount of the prize. The winner can take the ticket to a cashier station and redeem the amount on the ticket. In another embodiment, a voucher dispenser (not shown) can dispense the prize as a gift voucher.

One of ordinary skill in the art will recognize that the functions of the controller 914 can be performed through a plurality of processors. For example, one processor may be used to communicate with the data storage 514, another processor may be used to communicate with the memory 916, an additional processor may be used to communicate with the bill acceptor 920, another processor may be used to communicate with the bill dispenser 924, a processor may be used to communicate through the network 908, and a final processor may be used to control the audiovisual effects of the gaming machine 910. Further, multiple data storages or memories may be used to store different modules stored on the data storage 514. In addition, multiple memories may be used in place of the memory 916.

By receiving the guarantee from the game of chance guarantor 902, the gaming machine 910 can advertise a much larger prize than would ordinarily be advertised. Based on the probabilistic model discussed above, a significant number of players 912 that would not have ordinarily made wagers at the gaming machine 910 may be inclined to do so with the possibility of winning a large prize. The increased number of wagers bet results in a large increase in revenue to cover the larger prize. The net result is an exponential increase in revenue, not just a linear increase based on the increase in the prize. For instance, if the prize increases ten fold, the wagers placed may increase one hundred fold. In one embodiment, the ticket dispenser discussed above is used to dispense the large prize because the gaming machine 910 cannot accommodate holding such a large prize. In one embodiment, an additional reason for having a ticket dispenser to dispense a ticket indicating the prize to be awarded is that the casino operating the gaming machine is not paying the wager that is won. Rather, the game of chance guarantor 902 is paying the prize. The casino would only be paying a percentage of the wagers to the game of chance guarantor according to the stipulation that was provided in exchange for the guarantee. In one embodiment, a cashier's station can be operated by the game of chance guarantor 902 to pay the prize indicated on the ticket. In another embodiment, the casino can operate the cashier's station on behalf of the game of chance guarantor 902. Accordingly, the game of chance guarantor 902 can provide a sum of funds to the casino for placement at the cahier's station.

The probabilistic hardware and software configuration 900 is not limited to gaming machines. The probabilistic hardware and software configuration 900 can also be implemented at betting tables that have live operators which use a computerized console (not shown). Although the live operator will be-performing the functions of the game, the computerized console can be used to provide the guarantee and receive the stipulation as discussed above. Further, the probabilistic hardware and software configuration 900 can be used for games played on the Internet. The probabilistic hardware and software configuration 900 can be used with any computer network. The probabilistic hardware and software configuration 900 can be used in a computerized network that connects gaming machines. The probabilistic hardware and software configuration 900 can be used in a computerized network that connects gaming consoles. Further, the In addition, the probabilistic hardware and software configuration 900 can be used in conjunction with video lottery terminals. Finally, the probabilistic hardware and software configuration 900 can be used in a betting area having multiple consoles (not shown) at which the players 912 can make wagers. A live operator may or may not be present depending on the configuration. In one embodiment, each of the consoles has a separate payment acceptor and winnings dispenser for each console.

While the above description contains many specifics, these should not be construed as limitations on the scope of the invention, but rather as an exemplification of preferred embodiments thereof. The invention includes any combination or subcombination of the elements from the different species and/or embodiments disclosed herein. One skilled in the art will recognize that these features, and thus the scope of the present invention, should be interpreted in light of the following claims and any equivalents thereto.

1. A method of assuming risk for a lottery, the method comprising:
providing a guarantee of payment of a prize in a lottery, wherein the guarantee is in exchange for a stipulation of a percentage of ticket sales revenue in the lottery, wherein the providing the guarantee occurs prior to the ticket sales revenue in the lottery; and
receiving the percentage of the ticket sales in the lottery.

2. The method of claim 1, further comprising receiving the percentage of ticket sales revenue.

3. The method of claim 1, wherein the prize is a jackpot.

4. The method of claim 1, wherein the prize is a portion of a jackpot.

5. The method of claim 1, wherein the prize is secondary.

6. The method of claim 1, wherein the guarantee guarantees that the payment of the prize will be paid even if the ticket sales revenue is not greater in size than the payment of the prize.

7. The method of claim 1, wherein the guarantee guarantees that the payment of the prize will be paid even if the percentage of the ticket sales revenue is not greater in size than the payment of the prize.

8. The method of claim 1, wherein the providing the guarantee is effectuated to a jurisdiction.

9. The method of claim 1, wherein the providing the guarantee assumes the risk of the lottery.

10. The method of claim 1, wherein the lottery can be played on a video lottery terminal.

11. The method of claim 1, wherein the lottery can be played on a computing device operably connected to the Internet.

12. The method of claim 1, wherein a lottery ticket for the lottery can be purchased at a point of sale location.

13. The method of claim 1, further comprising obtaining insurance to provide the guarantee of payment.

14. A lottery risk assumption system, comprising:
a prize guarantee system that provides a guarantee of payment of a prize in a lottery, wherein the prize guarantee system provides the guarantee in exchange for a stipulation for a percentage of ticket sales revenue in the lottery, wherein the prize guarantee system provides the guarantee prior to the ticket sales in the lottery; and
a receiving system that receives the percentage of the ticket sales revenue in the lottery.

15. The lottery risk assumption system of claim 14, wherein the prize is a jackpot.

16. The lottery risk assumption system of claim 14, wherein the prize is a portion of a jackpot.

17. The lottery risk assumption system of claim 14, wherein the prize is secondary.

18. The lottery risk assumption system of claim 14, wherein the guarantee guarantees that the payment of the prize will be paid even if the ticket sales revenue is not greater in size than the payment of the prize.

19. The method of claim 14, wherein the guarantee guarantees that the payment of the prize will be paid even if the percentage of the ticket sales revenue is not greater in size than the payment of the prize.

20. The lottery risk assumption system of claim 14, wherein the prize guarantee system provides the guarantee to a jurisdiction.

21. The lottery risk assumption system of claim 14, wherein the prize guarantee system assumes the risk of the lottery.

22. The lottery risk assumption system of claim 14, wherein the lottery can be played on a video lottery terminal.

23. The lottery risk assumption system of claim 14, wherein the lottery can be played on a computing device operably connected to the Internet.

24. The lottery risk assumption system of claim 14, wherein a lottery ticket for the lottery can be purchased at a point of sale location.

25. The lottery risk assumption system of claim 14, further comprising an insurance system that provides the guarantee of payment.

26. A method of assuming risk for a game of chance, the method comprising:
providing a guarantee of payment of a prize in a game of chance, wherein the guarantee is in exchange for a stipulation for a percentage of wages bet in the game of chance, wherein the providing the guarantee occurs prior to the betting of wages in the game of chance; and
receiving the percentage of wages bet in the game of chance.

27. The method of claim 26, wherein the game of chance is poker.

28. The method of claim 26, wherein the game of chance is blackjack.

29. The method of claim 26, wherein the game of chance is a game that can be played on a slot machine.

30. The method of claim 26, wherein the game of chance is a game played in a casino.

31. The method of claim 26, wherein the game of chance can be played on a computing device operably connected to a network.

32. The method of claim 31, wherein the network is a wide area network.

33. The method of claim 31, wherein the network is a local area network.

34. The method of claim 31, wherein the network is the Internet.

35. A lottery system comprising:
a guarantee transmission module that transmits a guarantee through a network, wherein the guarantee guarantees the payment of a predetermined lottery prize;
a guarantee reception module that receives the guarantee through the network; and
a lottery creation module that establishes a lottery in which players can purchase tickets to win the predetermined lottery prize upon receipt of the guarantee from the guarantee reception module.

36. The lottery system of claim 35, wherein the lottery creation module provides an instruction to a point of sale location that allows the point of sale location to sell a ticket for the lottery.

37. The lottery system of claim 35, wherein the network is a local area network.

38. The lottery system of claim 35, wherein the network is a wide area network.

39. The lottery system of claim 35, wherein the network is the Internet.

40. The lottery system of claim 35, further comprising a risk module that upon the winning of the predetermined lottery prize determines if the tickets sales for the predetermined lottery prize are less than the predetermine lottery prize.

41. The lottery system of claim 40, wherein the risk module transmits a payment request through the network if the ticket sales for the predetermined lottery prize are less than the predetermined lottery prize.

42. The lottery system of claim 35, wherein the guarantee is provided in exchange for a stipulation of payment for a percentage of future ticket sales.

43. The lottery system of claim 35, further comprising a stipulation reception module that receives, through the network, the stipulation of payment for the percentage of future ticket sales.

44. The lottery system of claim 43, wherein the stipulation reception module is operably connected to the guarantee transmission module.

45. A game of chance guarantee system comprising:
a guarantee transmission module that transmits a guarantee through a network, wherein the guarantee guarantees the payment of a predetermined prize in a game of chance, wherein a prize can be won by winning the game of chance, wherein the game of chance is played according to a plurality of rules, wherein the guarantee is provided in exchange for a stipulation for a percentage of the wagers;
a guarantee reception module that receives the guarantee through the network; and
a game of chance creation module that establishes the game of chance upon receipt of the guarantee from the guarantee reception module, wherein players can make wagers in the game of chance.

46. The game of chance guarantee system of claim 45, wherein the game of chance creation module is housed within a gaming machine.

47. The game of chance guarantee system of claim 46, wherein the game of chance creation module establishes the game of chance by providing an instruction to a controller housed within the gaming machine to initiate the game of chance.

48. The game of chance guarantee system of claim 45, wherein the stipulation reception module receives, through the network, the stipulation of payment for the percentage of wagers.

49. The game of chance guarantee system of claim 45, wherein the network is a local area network.

50. The game of chance guarantee system of claim 45, wherein the network is a wide area network.

51. The game of chance guarantee system of claim 45, wherein the network is the Internet.

52. The game of chance guarantee system of claim 45, wherein the stipulation reception module is operably connected to the guarantee transmission module.

53. A method for guaranteeing a probabilistic lottery system, comprising:
providing a guarantee for a pre-determined prize, wherein the pre-determined prize can be advertised by a lottery operator, wherein the pre-determined prize is increased by a percentage of each ticket sale after each ticket sale; and
receiving a stipulation for a percentage of ticket sales in exchange for the providing the guarantee.

54. The method of claim 53, wherein the prize is a jackpot.

55. The method of claim 53, wherein the prize is a portion of a jackpot.

56. The method of claim 53, wherein the prize is secondary.

57. The method of claim 53, wherein the guarantee guarantees that the payment of the prize will be paid even if the ticket sales are not greater in size than the payment of the prize.

58. The method of claim 53, wherein the providing the guarantee is effectuated to a jurisdiction.

59. The method of claim 53, wherein the providing the guarantee assumes the risk of the lottery.

60. The method of claim 53, wherein the lottery can be played on a video lottery terminal.

61. The method of claim 53, wherein the lottery can be played on a computing device operably connected to the Internet.

62. The method of claim 53, wherein a lottery ticket for the lottery can be purchased at a point of sale location.

63. The method of claim 53, further comprising obtaining insurance to provide the guarantee of payment.
